(19) United States
(12) Patent Application Publication
(10) Pub. No.: US 2009/0168227 A1
(43) Pub. Date: Jul. 2, 2009

(54) Distributed track identifier on a hard disk drive

(76) Inventors: Mario Blaum, San Jose, CA (US); Jonathan Coker, Rochester, MN (US); Bruce A. Wilson, San Jose, CA (US); Mantle M. Yu, San Jose, CA (US)

Correspondence Address: HITACHI C/O WAGNER BLECHER LLP, 123 WESTRIDGE DRIVE, WATSONVILLE, CA, 95076, US

(21) Appl. No.: 12/006,429

(22) Filed: Dec. 31, 2007

(51) Int. Cl. G11B 5/596

(52) U.S. Cl. 360/77.05

(57) ABSTRACT

A magnetic disk for a hard disk drive comprising a distributed track identifier is described. The disk includes a first portion of a track identifier physically located at a first location on a disk sector and a second portion of the track identifier physically located at a second location on the disk sector wherein the first portion and the second portion of the track identifier are discontinuous on the sector.

### TECHNICAL FIELD

The present invention relates to the field of hard disk drive development, and more particularly to distributing a track identifier in a plurality of locations within a sector in a hard disk drive.

### BACKGROUND ART

At least one hard disk drive (HDD) is used in almost all computer system operations. In fact, most computing systems are not operational without some type of HDD to store the most basic computing information such as the boot operation, the operating system, the applications, and the like. In general, the HDD is a device which may or may not be removable, but without which the computing system will generally not operate.

The basic HDD model includes a storage disk or hard disk that spins at a designed rotational speed. An actuator arm with a suspended slider is utilized to reach out over the disk. The slider is coupled with a suspension that supports both the body of the slider and a head assembly that has a magnetic read/write transducer or head or heads for reading/writing information to or from a location on the disk. The complete head assembly, e.g., the suspension, slider, and head, is called a head gimbal assembly (HGA).

In operation, the hard disk is rotated at a set speed via a spindle motor assembly having a central drive hub. There are tracks at known intervals across the disk. When a request for a read of a specific portion or track is received, the hard disk aligns the head, via the arm, over the specific track location and the head reads the information from the disk. In the same manner, when a request for a write of a specific portion or track is received, the hard disk aligns the head, via the arm, over the specific track location and the head writes the information to the disk as a string of bits.

### SUMMARY

A magnetic disk for a hard disk drive comprising a distributed track identifier is described. The disk includes a first portion of a track identifier physically located at a first location on a disk sector and a second portion of the track identifier physically located at a second location on the disk sector wherein the first portion and the second portion of the track identifier are discontinuous on the sector.

### BRIEF DESCRIPTION OF THE DRAWINGS

FIG. 1 is a plain view of an HDD in accordance with one embodiment of the present invention.

FIG. 2 is an illustration of a magnetic disk with servo track in accordance with one embodiment of the present invention.

FIG. 3 is a block diagram illustrating a distributed track ID in accordance with one embodiment of the present invention.

FIG. 4 is a flowchart of a method for manufacturing a hard disk drive with a distributed track ID in accordance with one embodiment of the present invention.

### BEST MODES FOR CARRYING OUT THE INVENTION

Reference will now be made in detail to the alternative embodiment(s) of the present invention. While the invention will be described in conjunction with the alternative embodiment(s), it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

The discussion will begin with an overview of an HDD and components connected therewith. The discussion will then focus on embodiments of a method and system for a distributed track ID on a disk drive. Embodiments of the present invention are directed to a disk drive including a track ID for a particular sector that is distributed in a plurality of locations within the sector. With the distributed track ID of the present invention, the position of the track is determined by combining the distributed portions of the track ID.

### Overview

In general, embodiments of the present invention distribute track identification information to a plurality of locations for a single track identifier. In one embodiment of the invention, the track ID (TID), which identifies the position of a particular track is distributed into a plurality of discontinuous portions on the track. In one embodiment of the invention, each of the portions of the track identifier is encoded using a Gray code. A Gray code is a binary code where two successive values differ in only one bit. Gray code encoding is a well known method to identify track addresses. For brevity and clarity, specifics of Gray encoding will not be discussed herein, since they are well known.

### Operation

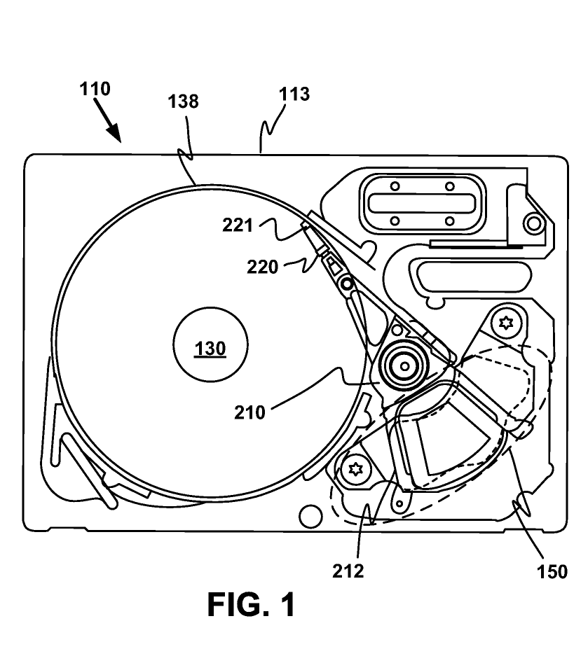

With reference now to FIG. 1, a schematic drawing of one embodiment of an information storage system including a magnetic hard disk file or HDD 110 for a computer system is shown, although only one head and one disk surface combination are shown. What is described herein for one head-disk combination is also applicable to multiple head-disk combinations. In other words, the present technology is independent of the number of head-disk combinations.

In general, HDD 110 has an outer housing 113 usually including a base portion (shown) and a top or cover (not shown). In one embodiment, housing 113 contains a disk pack having at least one media or magnetic disk 138. The disk pack (as represented by disk 138) defines an axis of rotation and a radial direction relative to the axis in which the disk pack is rotatable.

A spindle motor assembly having a central drive hub 130 operates as the axis and rotates the disk 138 or disks of the disk pack in the radial direction relative to housing 113. An actuator assembly 210 includes one or more actuator arms. When a number of actuator arms are present, they are usually represented in the form of a comb that is movably or pivotally mounted to base/housing 113. A controller 150 is also mounted to base 113 for selectively moving the actuator arms relative to the disk 138. Actuator assembly 210 may be coupled with a connector assembly, such as a flex cable to convey data between arm electronics and a host system, such as a computer, wherein HDD 110 resides.

In one embodiment, each actuator arm 210 has extending from it at least one cantilevered integrated lead suspension (ILS) 220. The ILS 220 may be any form of lead suspension that can be used in a data access storage device. The level of integration containing the slider 221, ILS 220, and read/write head is called the Head Gimbal Assembly (HGA).

The ILS 220 has a spring-like quality, which biases or presses the air-bearing surface of slider 221 against disk 138 to cause slider 221 to fly at a precise distance from disk 138. ILS 220 has a hinge area that provides for the spring-like quality, and a flexing cable-type interconnect that supports read and write traces and electrical connections through the hinge area. A voice coil 212, free to move within a conventional voice coil motor magnet assembly is also mounted to actuator arms 210 opposite the head gimbal assemblies. Movement of the actuator assembly 210 by controller 150 causes the head gimbal assembly to move along radial arcs across tracks on the surface of disk 138.

### Distributed Track ID

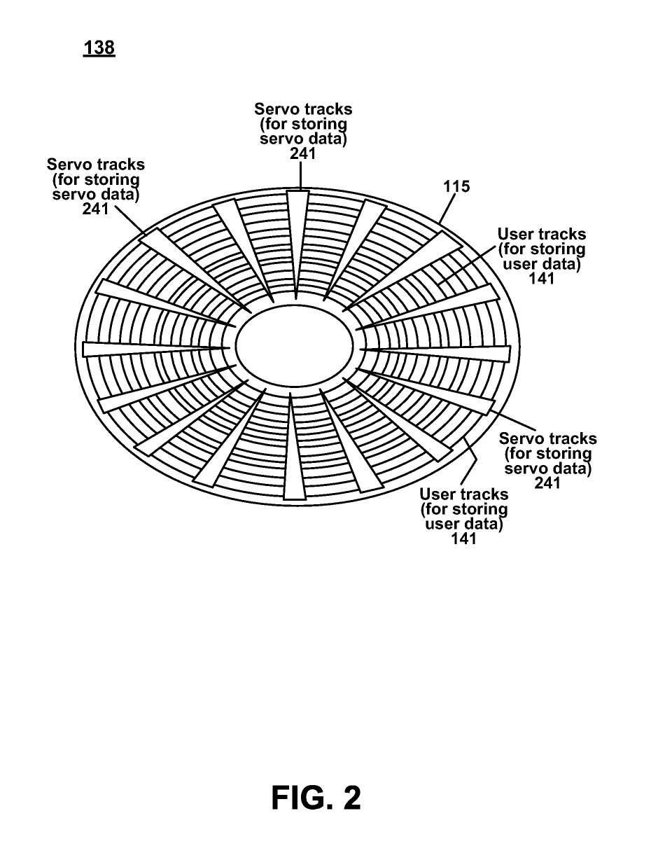

FIG. 2 is an exemplary diagram of a hard disk 138 having received a servo pattern and related track information as performed by a servo track writer. In one embodiment of the present invention, a track identifier for a single sector is distributed in a plurality of locations within the sector. Hard disk 138 is shown to include, in part, a plurality of regions for servo track data, e.g., servo tracks 241, onto which is written the necessary servo track information and a plurality of regions for user data, e.g., user tracks 141, onto which user data will be written and from which user data can be retrieved, subsequent to completion of the hard disk drive assembly into which a hard disk 138 is implemented.

In the shown embodiment, hard disk 138 contains sixteen servo pattern tracks 241 and user data regions 141. Alternatively, hard disk 138 may be comprised of fewer or greater numbers of servo track regions 241 and user data regions 141 in which servo track regions may utilize a lesser or greater amount of available data space. In one embodiment of the present invention, the servo tracks 241 for storing data include a distributed track ID where a track identifier is distributed among two or more locations on the track.

With the distributed track ID of the present invention, the position of a track is determined by all of the separate portions distributed within a single track. By reading one of the portions, an approximate location can be determined, but when all are read, the exact location can be determined. In one embodiment, the portions are Gray encoded.

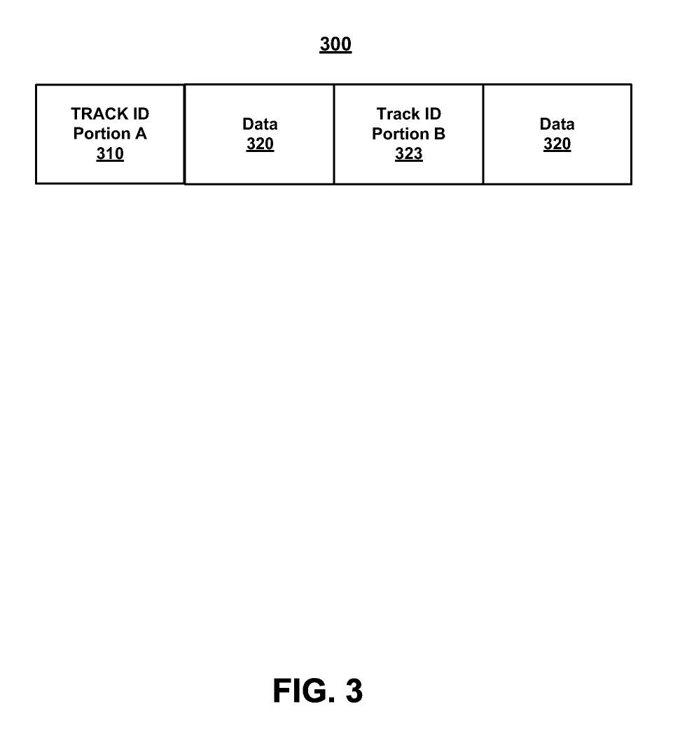

FIG. 3 is a block diagram illustrating a track ID distributed in a plurality of locations within a single track 300 in accordance with one embodiment of the present invention. In one embodiment, track 300 is a simplified illustration of part of a track. Track 300 includes data portions 320 and track ID portions 310 and 323. Track ID portion A 310 is a first portion of a track identifier that has been split into portions. Portion B 323 is a second portion of the same track ID. To determine the exact location of the track, the first portion A 310 and second portion B 323 are used. In one embodiment, the portions of the track ID are evenly distributed by size. For example, if the input track ID is twenty bits, each portion should be 10 bits.

### EXAMPLE CASES

The following examples are for illustration only; they show three of several possible methods for distributed TID and by no means are intended to limit the claims in this invention.

In a first example, we want to distribute the TID as much as possible, say, into TID0, TID1, TID2 . . . We assume that the sector number is known with total precision. We establish a minimal number of bits for the least significant bits (LSBs) in the TID that allows us an approximate idea of where the TID is (an estimator may help determine the exact location). In order to obtain completely the TID we need to determine the most significant bits (MSBs). So, basically we encode the LSBs using a Gray code and we distribute each of the MSBs.

Let's say, for the sake of discussion, that we need at least 6 LSBs to determine the TID. Let's assume also that we need 18 bits to determine completely the TID (i.e., we can have up to 2¹⁸ TIDs). Then we add one bit to the 6 LSBs (which are Gray encoded) to determine the MSBs in a distributed manner. Therefore, the TID takes 7 bits, of which the first one corresponds to a distributed MSB and the last 6 bits correspond to Gray encoded LSBs. Notice that in this case, in order to obtain the complete TID, we would need to read 12 consecutive sectors (corresponding to the 12 MSBs).

Below is a very simple example of this distributive method for a 7-bit TID with 3 bits of LSBs and 4 bits (in bold) of MSBs.

| | Sector | | | | | | | | |
|---|---|---|---|---|---|---|---|---|---|
| Track | 0 | 1 | 2 | 3 | 4 | 5 | 6 | 7 | . . . |
| 0 | 0000 | 0000 | 0000 | 0000 | 0000 | 0000 | 0000 | 0000 | . . . |
| 1 | 0001 | 0001 | 0001 | 0001 | 0001 | 0001 | 0001 | 0001 | . . . |
| 2 | 0011 | 0011 | 0011 | 0011 | 0011 | 0011 | 0011 | 0011 | . . . |
| 3 | 0010 | 0010 | 0010 | 0010 | 0010 | 0010 | 0010 | 0010 | . . . |
| 4 | 0110 | 0110 | 0110 | 0110 | 0110 | 0110 | 0110 | 0110 | . . . |
| 5 | 0111 | 0111 | 0111 | 0111 | 0111 | 0111 | 0111 | 0111 | . . . |
| 6 | 0101 | 0101 | 0101 | 0101 | 0101 | 0101 | 0101 | 0101 | . . . |
| 7 | 0100 | 0100 | 0100 | 0100 | 0100 | 0100 | 0100 | 0100 | . . . |
| 8 | 0000 | 0000 | 0000 | 0000 | 0000 | 0000 | 0000 | 0000 | . . . |
| 9 | 0001 | 0001 | 0001 | 0001 | 0001 | 0001 | 0001 | 0001 | . . . |
| 10 | 0011 | 0011 | 0011 | 0011 | 0011 | 0011 | 0011 | 0011 | . . . |
| 11 | 0010 | 0010 | 0010 | 0010 | 0010 | 0010 | 0010 | 0010 | . . . |
| 12 | 0110 | 0110 | 0110 | 0110 | 0110 | 0110 | 0110 | 0110 | . . . |
| 13 | 0111 | 0111 | 0111 | 0111 | 0111 | 0111 | 0111 | 0111 | . . . |
| 14 | 0101 | 0101 | 0101 | 0101 | 0101 | 0101 | 0101 | 0101 | . . . |
| 15 | 0100 | 0100 | 0100 | 0100 | 0100 | 0100 | 0100 | 0100 | . . . |
| 16 | 0000 | 0000 | 0000 | 0000 | 0000 | 0000 | 0000 | 0000 | . . . |
| . | . | . | . | . | . | . | . | . | . |
| . | . | . | . | . | . | . | . | . | . |
| . | . | . | . | . | . | . | . | . | . |

As a second example, let G₁ be a Gray code with 2l₁ elements and G₂ be a Gray code with 2l₂ elements such that greatest common divisor between l₁ and l₂ is 1, i.e., GCD(l₁,l₂)=1. Let us illustrate the construction with a very simplified example. Let G₁ be a regular Gray code with length 3 and 8=(2)(4) elements and G₂ be a Gray code with length 3 and 6=(2)(3) elements. Specifically,

$$= ( \begin{matrix}\begin{matrix}\begin{matrix}\begin{matrix}\begin{matrix}\begin{matrix}000 \\ 001\end{matrix} \\ 011 \\ 010\end{matrix} \\ 110\end{matrix} \\ 111\end{matrix} \\ 101\end{matrix} \\ 100\end{matrix} ) and = ( \begin{matrix}\begin{matrix}\begin{matrix}\begin{matrix}\begin{matrix}000 \\ 001\end{matrix} \\ 011\end{matrix} \\ 010\end{matrix} \\ 110\end{matrix} \\ 100\end{matrix} )$$

Combining G₁ and G₂, we obtain a combined code with 24 elements, the least common multiple (LCM) between 8 and 6.

$$= ( \begin{matrix}000 & 000 \\ 001 & 001 \\ 011 & 011 \\ 010 & 010 \\ 110 & 110 \\ 111 & \underline{100} \\ 101 & 000 \\ \underline{100} & 001 \\ 000 & 011 \\ 001 & 010 \\ 011 & 110 \\ 010 & \underline{100} \\ 110 & 000 \\ 111 & 001 \\ 101 & 011 \\ \underline{100} & 010 \\ 000 & 110 \\ 001 & \underline{100} \\ 011 & 000 \\ 010 & 001 \\ 110 & 011 \\ 111 & 010 \\ 101 & 110 \\ 100 & 100\end{matrix} )$$

The construction can be generalized. A case relevant to applications is taking as G₁ the Gray code with length 10 and 2¹⁰=1024 elements, and as G₂ the same code with 2 vectors deleted, thus, G₂ has also length 10 but 2¹⁰−2=1022 elements.

The total number of elements of the combined code is then LCM(1024,1022)=523264 elements, which may be enough for most applications. If that is the case, we are writing 10 bits in the TID area with this distributed TID scheme, as opposed to the 19 bits necessary to write the whole TID.

Further generalizations involve taking more than two codes, but we omit their description here, since they should be straightforward to those versed in the art.

As a third exemplary construction, consider a regular Gray code. Denote its rows by g₀,g₁, . . . A property of such a Gray code is the following: rows g₂ᵢ and g₂ᵢ₊₃ are at distance 1. We can exploit this property to obtain a code such that, given a regular Gray code G of length m and 2m codewords, we obtain a composed code with 2^{2m-1} codewords as follows:

$$= \begin{matrix}\begin{matrix}\begin{matrix}\begin{matrix}\begin{matrix}{\underline{g}}_{1} \\ {\underline{g}}_{2}\end{matrix} \\ ⋯\end{matrix} \\ {\underline{g}}_{{2}^{m} - 1}\end{matrix} \\ {\underline{g}}_{0}\end{matrix} & \begin{matrix}\begin{matrix}\begin{matrix}\begin{matrix}{\underline{g}}_{0} \\ {\underline{g}}_{1}\end{matrix} \\ ⋯\end{matrix} \\ {\underline{g}}_{{2}^{m} - 2}\end{matrix} \\ {\underline{g}}_{{2}^{m} - 1}\end{matrix} \\ \begin{matrix}\begin{matrix}\begin{matrix}\begin{matrix}{\underline{g}}_{3} \\ {\underline{g}}_{4}\end{matrix} \\ ⋯\end{matrix} \\ {\underline{g}}_{1}\end{matrix} \\ {\underline{g}}_{2}\end{matrix} & \begin{matrix}\begin{matrix}\begin{matrix}\begin{matrix}{\underline{g}}_{0} \\ {\underline{g}}_{1}\end{matrix} \\ ⋯\end{matrix} \\ {\underline{g}}_{{2}^{m} - 2}\end{matrix} \\ {\underline{g}}_{{2}^{m} - 1}\end{matrix} \\ \begin{matrix}\begin{matrix}{\underline{g}}_{5} \\ ⋯\end{matrix} \\ ⋯\end{matrix} & \begin{matrix}\begin{matrix}{\underline{g}}_{{2}^{m} - 1} \\ ⋯\end{matrix} \\ ⋯\end{matrix} \\ \begin{matrix}\begin{matrix}\begin{matrix}\begin{matrix}{\underline{g}}_{{2}^{m} - 1} \\ {\underline{g}}_{0}\end{matrix} \\ ⋯\end{matrix} \\ {\underline{g}}_{{2}^{m} - 3}\end{matrix} \\ {\underline{g}}_{{2}^{m} - 2}\end{matrix} & \begin{matrix}\begin{matrix}\begin{matrix}\begin{matrix}{\underline{g}}_{0} \\ {\underline{g}}_{1}\end{matrix} \\ ⋯\end{matrix} \\ {\underline{g}}_{{2}^{m} - 2}\end{matrix} \\ {\underline{g}}_{{2}^{m} - 1}\end{matrix}\end{matrix}$$

For example, if G₃ is the regular Gray code of length 3, then

$$= \begin{matrix}\begin{matrix}\begin{matrix}\begin{matrix}\begin{matrix}\begin{matrix}\begin{matrix}\begin{matrix}001 \\ 011\end{matrix} \\ 010\end{matrix} \\ 110\end{matrix} \\ 111\end{matrix} \\ 101\end{matrix} \\ 100\end{matrix} \\ 000\end{matrix} & \begin{matrix}\begin{matrix}\begin{matrix}\begin{matrix}\begin{matrix}\begin{matrix}\begin{matrix}000 \\ 001\end{matrix} \\ 011\end{matrix} \\ 010\end{matrix} \\ 110\end{matrix} \\ 111\end{matrix} \\ 101\end{matrix} \\ 100\end{matrix} & \begin{matrix}\begin{matrix}\begin{matrix}\begin{matrix}\begin{matrix}\begin{matrix}\begin{matrix}111 \\ 101\end{matrix} \\ 100\end{matrix} \\ 000\end{matrix} \\ 001\end{matrix} \\ 011\end{matrix} \\ 010\end{matrix} \\ 110\end{matrix} & \begin{matrix}\begin{matrix}\begin{matrix}\begin{matrix}\begin{matrix}\begin{matrix}\begin{matrix}000 \\ 001\end{matrix} \\ 011\end{matrix} \\ 010\end{matrix} \\ 110\end{matrix} \\ 111\end{matrix} \\ 101\end{matrix} \\ 100\end{matrix} \\ \begin{matrix}\begin{matrix}\begin{matrix}\begin{matrix}\begin{matrix}\begin{matrix}\begin{matrix}010 \\ 110\end{matrix} \\ 111\end{matrix} \\ 101\end{matrix} \\ 100\end{matrix} \\ 000\end{matrix} \\ 001\end{matrix} \\ 011\end{matrix} & \begin{matrix}\begin{matrix}\begin{matrix}\begin{matrix}\begin{matrix}\begin{matrix}\begin{matrix}000 \\ 001\end{matrix} \\ 011\end{matrix} \\ 010\end{matrix} \\ 110\end{matrix} \\ 111\end{matrix} \\ 101\end{matrix} \\ 100\end{matrix} & \begin{matrix}\begin{matrix}\begin{matrix}\begin{matrix}\begin{matrix}\begin{matrix}\begin{matrix}100 \\ 000\end{matrix} \\ 001\end{matrix} \\ 011\end{matrix} \\ 010\end{matrix} \\ 110\end{matrix} \\ 111\end{matrix} \\ 101\end{matrix} & \begin{matrix}\begin{matrix}\begin{matrix}\begin{matrix}\begin{matrix}\begin{matrix}\begin{matrix}000 \\ 001\end{matrix} \\ 011\end{matrix} \\ 010\end{matrix} \\ 110\end{matrix} \\ 111\end{matrix} \\ 101\end{matrix} \\ 100\end{matrix}\end{matrix}$$

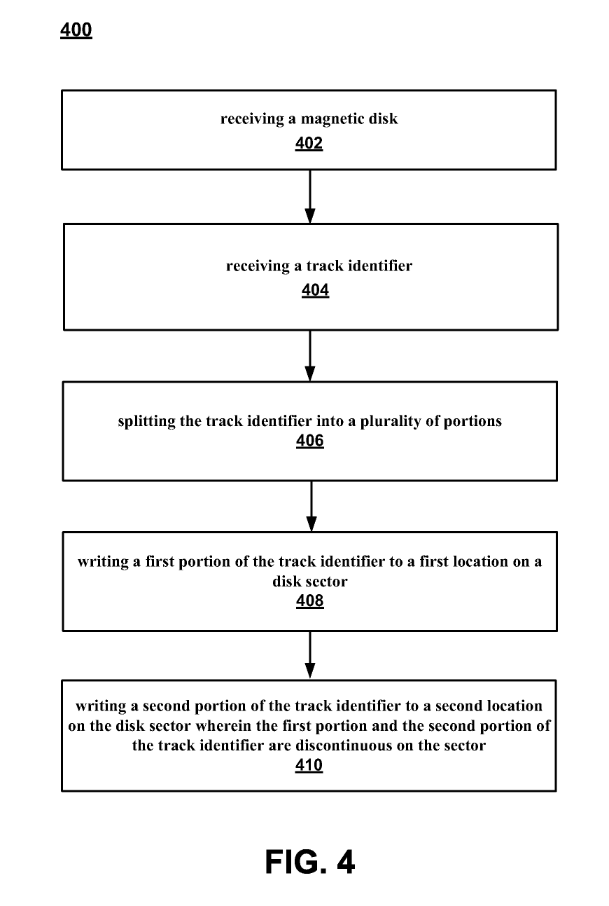

FIG. 4 is a flowchart of a method 400 for manufacturing a hard disk drive with a distributed track ID in accordance with one embodiment of the present invention.

At 402, 400 includes receiving a magnetic disk.

At 404, 400 includes receiving a track identifier. In one embodiment, the track identifier is twenty bits in length.

At 406, 400 includes splitting the track identifier into a plurality of portions. In one embodiment, the track identifier is split into equal portions in length.

At 408, 400 includes writing a first portion of the track identifier to a first location on a disk sector. In one embodiment, the first portion is written as Gray Code.

At 410, 400 includes writing a second portion of the track identifier to a second location on the disk sector wherein the first and second portions of the track identifier are discontinuous on the sector.

Thus, embodiments of the present invention provide a method and apparatus for a distributed track ID within a sector.

Example embodiments of the present technology are thus described. Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A magnetic disk for a hard disk drive comprising:
a first portion of a track identifier physically located at a first location on a disk sector; and
a second portion of said track identifier physically located at a second location on said disk sector wherein said first portion and said second portion of said track identifier are discontinuous on said sector.

2. The magnetic disk of claim 1 wherein said first portion and said second portion of said track identifier comprise Gray Code.

3. The magnetic disk of claim 1 wherein each of said first portion and said second portions of said track identifier separately maintain a Gray Code property.

4. The magnetic disk of claim 1 wherein said first portion and said second portion of said track identifier each comprises an odd number of ones.

5. The magnetic disk of claim 1 wherein said first portion and said second portion of said track identifier are generated from a nineteen bit input vector.

6. The magnetic disk of claim 1 wherein decoding said first and second portions of said track identifier results in a nineteen bit track identification vector.

7. The magnetic disk of claim 1 wherein said first portion and said second portion of said track identifier can be combined to determine a track identification address.

8. The magnetic disk of claim 1 wherein the track identifier is distributed in a plurality of portions, such that in each portion the least significant bits are written using a Gray code, while the most significant bits are distributed, preferably one bit per portion.

9. A disk drive system comprising:
a housing;
a motor assembly coupled with said housing, said motor assembly for rotating a magnetic disk, said magnetic disk comprising:
a first portion of a track identifier physically located at a first location on a disk sector; and
a second portion of said track identifier physically located at a second location on said disk sector wherein said first portion and said second portion of said track identifier are discontinuous on said sector

10. The disk drive of claim 9 wherein said first portion and said second portion of said track identifier comprise Gray Code.

11. The disk drive of claim 9 wherein each of said first portion and said second portions of said track identifier separately maintain a Gray Code property.

12. The disk drive of claim 9 wherein said first portion and said second portion of said track identifier each comprises an odd number of ones.

13. The disk drive of claim 9 wherein said first portion and said second portion of said track identifier are generated from a nineteen bit input vector.

14. The disk drive of claim 9 wherein decoding said first and second portions of said track identifier results in a nineteen bit track identification vector.

15. The disk drive of claim 9 wherein said first portion and said second portion of said track identifier can be combined to determine a track identification address.

16. A method for manufacturing a hard disk drive comprising:
receiving a magnetic disk;
receiving a track identifier;
splitting said track identifier into a plurality of portions;
writing a first portion of said track identifier to a first location on a disk sector; and
writing a second portion of said track identifier to a second location on said disk sector wherein said first portion and said second portion of said track identifier are discontinuous on said sector.

17. The method of claim 16 wherein said first portion and said second portion of said track identifier are written in Gray Code.

18. The method of claim 16 wherein each of said first portion and said second portions of said track identifier separately maintain a Grey Code property.

19. The method of claim 16 wherein said first portion and said second portion of said track identifier each are written with an odd number of ones.

20. The method of claim 16 wherein said track identifier is received in the form of a twenty bit vector.
